(19) United States
(12) Patent Application Publication
(10) Pub. No.: US 2004/0170780 A1
(43) Pub. Date: Sep. 2, 2004

(54) Method and compostion for an in-mold liner

(76) Inventor: Jean Pierre Giraud, Paris (FR)

Correspondence Address: GREENBERG TRAURIG, LLP, 885 3RD AVENUE, NEW YORK, NY, 10022, US

(21) Appl. No.: 10/213,516

(22) Filed: Aug. 6, 2002

Related U.S. Application Data
(60) Provisional application No. 60/310,374, filed on Aug. 6, 2001.

(51) Int. Cl. F16L 1/00

(52) U.S. Cl. 428/34.1

(57) ABSTRACT

The present invention is a directed to a container provided with a liner formed in the mold which changes the properties of the container, when compared to a container not having the liner, and methods of forming same. The liner may exhibit absorption properties, it may release an agent into the surrounding environment, it may undergo some action in response to a condition or thing in the environment, such as the presence of water or a gas. It may provide a barrier, and/or it may exhibit permeability.

### RELATED APPLICATIONS

Pursuant to the appropriate section of title 35, United States Code, this application claims the benefit of the earlier filing date of Provisional Application Serial No. 60/310,374 filed Aug. 6, 2001.

### FIELD OF THE INVENTION

The present invention is a directed to a container provided with a liner formed in the mold which changes the properties of the container, when compared to a container not having the liner, and methods of forming same. The liner may exhibit absorption properties, it may release an agent into the surrounding environment, it may undergo some action in response to a condition or thing in the environment, such as the presence of water or a gas. It may provide a barrier, and/or it may exhibit permeability.

### DESCRIPTION OF THE INVENTION

The present invention relates to an in-mold lining method that results in a container having at least one liner attached to the container. For purposes of the present invention, the liner may be composed of one or more of the following: a composition containing an absorption material, a composition containing a releasing material, a composition containing an activation material, a barrier material, and/or a permeable material. Examples of absorption material include, but are not limited to one or more one or more desiccating compounds. In general, there are three primary types of desiccating compounds that may be used with the present invention. The first type comprises chemical compounds that can combine with water to form hydrates. Examples of such desiccant are anhydrous salts which tend to absorb water or moisture and form a stable hydrate. In this reaction with the moisture, a stable compound is formed within which the moisture is held and prevented from release by chemical interaction.

The second type of desiccant compounds are those which are considered to be reactive. These compounds typically undergo a chemical reaction with water or moisture and form new compounds within which the water is combined. These newly formed compounds are generally irreversible at low temperature and require a significant amount of energy to be regenerated so that they may be reused as a desiccant. These reactive type desiccants are mainly used in solvent drying and as water-absorbing materials to polymers which must themselves be maintained in a moisture reduced state.

The third type of desiccants obtain their moisture absorbing capabilities through physical absorption. The absorption process is accomplished because of a fine capillary morphology of the desiccant particles which pulls moisture therethrough. The pore size of the capillaries, as well as the capillaries' density determine the absorption properties of the desiccant. Examples of these physical absorption desiccants include molecular sieves, silica gels, clays (e.g. montmorillimite clay), certain synthetic polymers (e.g. those used in baby diapers), and starches. Because these types of physical absorption desiccants are both inert and non-water soluble, they are preferred for many applications.

In another embodiment, the absorbing materials may be either: (1) metals and alloys such as, but not limited to, nickel, copper, aluminum, silicon, solder, silver, gold; (2) metal-plated particulate such as silver-plated copper, silver-placed nickel, silver-plated glass microspheres; (3) inorganics such as BaTiO₃, SrTiO₃, SiO₂, Al₂O₃, ZnO, TiO₂, MnO, CuO, Sb₂O₃, WC, fused silica, fumed silica, amorphous fused silica, sol-gel silica, sol-gel titanates, mixed titanates, ion exchange resins, lithium-containing ceramics, hollow glass microspheres; (4) carbon-based materials such as carbon, activated charcoal, carbon black, ketchem black, diamond powder; and (5) elastomers, such as polybutadiene, polysiloxane, and semi-metals, ceramic. In another example, the absorbing material may be calcium oxide. In the presence of moisture and carbon dioxide, the calcium oxide is converted to calcium carbonate. Accordingly, calcium oxide may be used as the absorbing material in application where absorption of carbon dioxide is needed. Such applications include preserving fresh foods (e.g. fruits and vegetables) that give off carbon dioxide.

It is believed that the higher the absorbing material concentration in the mixture, the greater the absorption capacity will be of the final composition. However, the higher absorbing material concentration should cause the body to be more brittle and the mixture to be more difficult to either thermally form, extrude or injection mold. In one embodiment, the absorbing material loading level can range from 10% to 20%, 20% to 40% and 40% to 60% by weight with respect to the polymer.

In yet another embodiment, examples of releasing material include, but are not limited to, any suitable form which will release dispersant to surrounding atmosphere, including solid, gel, liquid, and in some cases a gas. These substances can perform a variety of functions including: serving as a fragrance, flavor, or perfume source; supplying a biologically active ingredient such as pesticide, pest repellent, antimicrobials, bait, aromatic medicines, etc.; providing humidifying or desiccating substances; delivering air-borne active chemicals, such as corrosion inhibitors; replenishment such as carbon dioxide; ripening agents and odor-making agents, etc. For example, the releasing material may have biocide properties. Such biocides may include, but are not limited to, pesticides, herbicides, nematacides, fungicides, rodenticides and/or mixtures thereof.

Other releasing materials include fragrances, including natural, essential oils and synthetic perfumes, and blends thereof. Typical perfumery materials which may form part of, or possible the whole of, the active ingredient include: natural essential oils such as lemon oil, mandarin oil, clove leaf oil, petitgrain oil, cedar wood oil, patchouli oil, lavandin oil, neroli oil, ylang oil, rose absolute or jasmin absolute; natural resins such as labdanum resin or olibanum resin; single perfumery chemicals which may be isolated from natural sources of manufactured synthetically, as for example alcohols such as geraniol, nerol, citronellol, linalol, tetrahydrogeraniol, betaphenylethyl alcohol, methyl phenyl carbinol, dimethyl benzyl carbinol, menthol or cedrol; acetates and other esters derived form such alcohols-aldehydes such as citral, citronellal, hydroxycitronellal, lauric aldehyde, undecylenic aldehyde, cinnamaldehyde, amyl cinnamic aldehyde, vanillin or heliotropin; acetals derived from such aldehydes; ketones such as methyl hexyl ketone, the ionones and methylionones; phenolic compounds such as eugenol and isoeugenol; synthetic musks such as musk xylene, musk ketone and ethylene brassylate.

In yet another embodiment, the activation material may include a material that requires a specific liquid, vapor, or gas to activate the material and, after activation, the material releases the desired vapor, liquid, or gas. In one embodiment, moisture is used to activate the material. In another embodiment, oxygen is used to activate the material. In a further embodiment, an acid is used to activate the material. In yet a further embodiment, a base is used to activate the material. In yet another embodiment, a variety of materials may be released. Such material may comprise any suitable form which will release dispersant to surrounding atmosphere, including solid, gel, liquid, and, in some cases, a gas. These substances can perform a variety of functions, including: serving as a fragrance or perfume source; supplying a biologically active ingredient such as a biocide, antimicrobial agent, pesticide, pest repellent, bait, aromatic medicine, etc.; providing humidifying or desiccating substances; or delivering air-borne active chemicals, such as corrosion inhibitors, ripening agents and odor-masking agents.

Another example of activation materials are enzyme systems. Suitable enzyme systems may include glucose oxidase; a glucose/glucose oxidase combination; a glucose oxidase/sucrose combination; a starch/amylase/glucose oxidase combination; a cellulose/cellulase/glucose oxidase combination; a milk powder/lactase/glucose oxidase combination; a glucose oxidase/glucose isomerase/fructose combination; a glucose oxidase/lactase/whey solids/lactose combination; a glucose oxidase/lactase/lactose combination; a glucose oxidase/maltase/starch combination; a glucose oxidase/maltase/maltose combination; a mushroom tyrosinase/tyrosine combination; a glucose oxidase/sucrose/sucrase combination; an alcohol/alcohol oxidase; a lactate/lactate oxidase; an amino acid/amino acid oxidase; a golactose/golactose oxidase; a xanthine/xanthine oxidase; an amine/amine oxidase; an ascorbate/ascorbate oxidase; a chelione/chelione oxidase; and any combination of these enzymes.

In yet another embodiment of activation material, some catalyzed reactions may generate hydrogen peroxide as a byproduct. The released hydrogen peroxide may be of some benefit to extend shelf life of meats, poultry and fish if the hydrogen peroxide is in direct contact with the wet surfaces of those foods. Alternatively, concern about the generation of hydrogen peroxide may be minimized by including catalase in the enzyme system.

In a further embodiment, activation material may also be added to provide the polymer with one or more specific properties, such as acidity, basicity, thermal conductivity, electrical conductivity, dimensional stability, low dielectric constant, high-dielectric constant, ion-exchange capabilities, galvanic potential, flame retardency, etc. It is believed that the higher the activation material concentration in the mixture, the greater the capacity will be of the final material. However, the higher activation material concentration should cause the body to be more brittle and the mixture to be more difficult to either thermally form, extrude or injection mold. In one embodiment, the activation material loading level can range from 10% to 20%, 20% to 40% and 40% to 60% by weight with respect to the polymer.

Suitable barrier and permeable materials include the conventional material that are used to achieve enhanced barrier or permeable properties. It is to be understood that two or more materials may be added with one functioning as an absorbing material and the other then functioning as a releasing material to form an activation material. An example would be a desiccant (i.e. absorbing) and a releasing material such as a dispersant.

One advantage of the present invention includes the ability to employ a liner of any desired thickness. For example, in one embodiment, a liner may be employed that is thinner than is typically used for the plastic layer during injection molding or than is typically used for either parts of a comolded material. As such, in one embodiment, the present invention allows for placing an additional plastic layer that is typically thinner than previously used in co-molding processes. In a specific embodiment, the thickness of the liner may range from about 0.0001 inches to about 0.001 inches, more particularly from about 0.00025 inches to about 0.00075 inches.

In one embodiment, the in-mold liner process is performed by inserting a liner within an open mold prior to closing of the mold around an extruded hot plastic tube or a heated injection molded plastic preform. For example, the liner can be the same shape as the molded plastic (e.g. the liner insert can be a cylindrical shape with a closed bottom that is inside a comparably shaped cylindrical container). Subsequent mold closing and extrusion forms the hot plastic around the liner to the shape of the mold and activates a heat sensitive adhesive that provides a permanent bond which is substantially incapable of being broken by moisture or otherwise. Also, such in-mold lining provides a smooth transition between the liner and the adjacent surface of the container and may further provide additional strength since the liner cooperates with the container wall in resisting deformation. Such strengthening also allows the use of less plastic to blow mold the container and thereby reduces the ultimate cost to the consumer.

In another embodiment, the in-mold liner of the present invention may have dual roles—the liner may both be a liner and a printed label. For example, the liner may have printed information on one side and the composition with the desired property (e.g. absorption, releasing, barrier, and/or activation) on the other side. In another specific example, the container can be composed of a clear plastic and the liner can be inserted in the inside of the container. The printing can be located on the side of the liner facing the outside of container. As such, the liner could be tamper-resistant because the clear plastic is protecting the printing (e.g. this could be used in application where tamper-resistance of labels is important such as in the pharmaceutical industry). In addition, the side of the liner facing the inside of the container can have the desired composition.

In a further embodiment, the liner may be adhered to the injected molded plastic by employing a liner composed of a polymeric material that has a melting point that is substantially equivalent to the injected polymeric material. As such, when the polymeric material is injected into the cavity where the liner is secured, the liner is heated to a sufficient temperature to melt the liner to the point where the surface contacting the injected polymeric material is adhered to the surface but below the point where the liner is deformed. Consequently, suitable polymeric materials including blends can be formulated to achieve this result.

Examples of suitable liners include, but are not limited to, paper-like materials and thermoplastic materials including polyolefins such as polypropylene and polyethylene, polyisoprene, polybutadiene, polybutene, polysiloxane, polycarbonates, polyamides, ethylene-vinyl acetate copolymers, ethylene-methacrylate copolymer, poly(vinyl chloride), polystyrene, polyesters, polyanhydrides, polyacrylianitrile, polysulfones, polyacrylic ester, acrylic, polyurethane and polyacetal, or copolymers or mixtures thereof.

In one specific embodiment, the liner in a form of a film or other comparable geometry is prepared for input into the system (e.g. a roll or stack of material). In the next step, a robotic arm or other mechanism that can properly place the liner in the mold (e.g. “a pick and place) is employed. The mechanism picks-up the liner and positions the liner in the mold apparatus having transfer heads that engage and move the labels. For example, transfer heads are connected to a drive mechanism that cycle the heads back and forth between a liner pick up position and a liner transfer position. The heads carry vacuum cups for engaging and holding liners. When in the liner pick up positions, the heads are moved against liners to form vacuum connections with the liners. Movement of the heads away from the pick up position pulls liners. The liners are carried with the heads for subsequent placement in cavities in the mold sections.

In one embodiment, the liner is placed on the core. The liner may be held in place in the mold by conventional methods known in the art such as suction or charging the film with static electricity or any combination of methods. Subsequently, the mold closes and plastic is injected into the mold. The mold then opens and the molded part is ejected with the liner attached to the plastic.

In a further embodiment, the liner can be secured to the core by first applying the liner to the core and then employing hot air to slightly shrink the polymeric liner to the core.

In embodiments relating to the geometrical shape of the liner prior to placing the liner in the mold, the liner may be sized so that each liner is the size of the circumference of the surface where the liner will be placed. For example, if the liner is placed in the inside of the container then the liner may be sized so that the liner is equivalent to the size of the inside circumference of the container. If the liner is placed in the outside of the container then the liner may be sized so that the liner is equivalent to the size of the outside circumference of the container. In another example, if the container is not cylindrical, then the liner is sized so that the liner has the equivalent size and shape of, if placed on the inside surface of the container, the inside shape of the container, and/or, if placed on the outside surface of the container, the outside shape of the container.

In yet another embodiment relating to the geometric shape of the liner prior to placing the liner in the mold, the liner is formed as a tube-like shape (e.g. the liner is extruded in the form of a tube-like shape). In one example, the continuous tube from the extruder is cut to conform to the size of the desired container. Subsequently, the liner is placed on the core and the plastic is then injected into the mold. As a result, an in-process sleeve processed in employed.

In yet another embodiment, a printed film can be co-laminated to the liner prior to placing in the mold. Alternatively, two or polymeric materials may be co-laminated to form a laminated liner.

In a further embodiment, the liner can be composed of a foam-type material in the construction of a dual wall insulated cup to enhance the insulation properties of the cup. In operation, the foam-type liner is first placed on the core. The foam-type liner is then adhered to the outer cup when the plastic is injected in the mold to form the outer cup. Subsequently, an inner cup is inserted in the outer cup to form a gap between the outer and inner walls whereby the foam-type liner is within the gap. In a specific embodiment, the foam-type liner is of a sufficient thickness so that, when the inner cup is placed in the outer cup, the foam-type liner does not contact the inner cup.

In one embodiment, the present invention may be employed with a “rotating table” injection molding equipment. For example, in a first position, a first liner of the present invention is first placed on the core. The core is rotated to a second position where the mold is closed and a first plastic composition is injected in the mold over the first liner. The mold is then opened and the core is rotated to a third position where a second liner is placed over the core containing the injection molded plastic composition and the first liner. The second liner may be composed of the same material as the first liner or may be composed of a different material than the first liner. The core is then rotated to a fourth position where the mold is closed and a second plastic composition is injected in the mold. The second plastic composition may be composed of the same material as the first plastic composition or may be composed of a different material then the first plastic composition. The mold is then opened and the multi-layered material is then ejected from the mold.

In yet another embodiment, the liner of the present invention may also include printed information on either one surface of the liner or on both surfaces of the liner. In this way, the liner may have dual purposes—both as a material with specific properties (e.g. barrier, permeability) and as a label with printed information.

In one specific embodiment, a plastic container may be produced that has high oxygen barrier properties and thus, may be used in applications where metal containers were previously used because of their oxygen barrier properties. For example, EVOH (i.e. ethylene vinyl alcohol) film may be used as the liner to form at least a two-layered composite material.

In another specific embodiment, a film layer may be used that acts as a “skin” layer between the plastic composition of the container and the material in the container. In this way, the material in the container does not come into direct contact with the plastic composition of the container. For example, the plastic composition may be composed of an absorption material, a releasing material and/or an activation material. In order to eliminate any risk of the plastic composition contaminating the contents of the container (e.g. pharmaceutical products), a liner is placed as the outside layer of the plastic composition so that the contents of the container do not contact the plastic composition. The liner may be selected as a material that does not contaminate the product (e.g. a material that has been used with the product and thus, has been recognized as safe for use with the product). At the same time, the liner may be selected as a material that does not inhibit the properties of the plastic composition. For example, for a plastic composition that is composed of a water absorption material (e.g. a desiccant), a liner is selected with high water permeability properties. In another example, for a plastic composition that is composed of a material that absorbs a specific gas or vapor, a liner is selected with high permeability properties for the specific gas or vapor. In yet another example, for a plastic composition that is composed of a material that releases a specific material, a liner is selected with high permeability properties for the specific material. In a further example, for a plastic composition that is composed of an activation material, a liner is selected with high permeability properties for the specific activation material. Moreover, the liner may be composed of a material that has a specific transport rate and thus, the liner may assist in controlling the rate of transfer (and thus the amount of transfer) of either the absorbing, releasing or activation material to the plastic composition.

In yet another specific embodiment, an oxygen absorber composition may be produced. For example, a plastic with high oxygen barrier properties may be used as the injection molded plastic container. A liner is placed on the inside of the plastic container (i.e. the surface that comes into contact with the contents of the container) that is composed of the oxygen absorber. In a specific example, a film material, manufactured by Chevron with a trade name “EMCM” is used as the oxygen absorber liner. The material is composed of a polyolefin with cobalt carboxylate salt and BBP3. In yet another example, an additional liner is placed over the oxygen absorber liner on the inside of the plastic container (i.e. the surface that comes into contact with the contents of the container) that is compatible with the contents of the container and thus, acts as the “skin” layer. Suitable materials for the liner include material that are permeable to oxygen.

In another embodiment, the liner is inserted into open mold cavities in a matter of fractions of a second prior to the mold halves closing about a core to produce a desired container. Each liner is laid against its respective mold cavity wall and held therein as it closes. In one example, a supply of air is blown into the resin therein to make it conform to the mold contours with the liner on the cavity wall being correspondingly molded upon the resinous container wall.

In one example, when liners are supplied to the mold, (e.g. one to each mold half), a mechanical or other suitable method of inserting and applying the liners to the walls of the open halves is provided which must act sufficiently quickly before the two halves close otherwise imparting a time delay in the molding cycle. Since it is important for efficiency of operation that the plastic flow from the extruder not be interrupted, the time available is limited for insertion of liners on the walls of the mold halves without incurring a delay in the production cycle. This requires rapid action by the mechanism for inserting the liners on the walls of the mold halves. That is, the liner inserter must get in between the mold halves quickly while they are open and get out quickly before the space between the closing mold halves becomes too small for the mechanism to be safely present therein.

In one example, the mold cavities (e.g. holes of about 0.002 inch diameters) are each provided with spaced small masked openings at which a negative pressure is provided by connection of the mold half to a negative pressure source. By this means when a liner is inserted in the cavity, the spaced negative pressure spots act to receive the liner from a liner carrying mechanism and to hold the liner against the interior wall of the cavity. The liner carrying mechanism is thereupon withdrawn from the cavity region of the mold. A negative pressure is established in a manifold. The manifold may be a conventional pressurized air flow manifold which generates a negative pressure. During movement to the pick up positions, the liners may be rotated to assure proper angular orientation when picked up by the in-mold liner apparatus for placement in the mold sections. In one example, vacuum ports in suction cups of the pick up mechanism are continuously connected to a low vacuum source through vacuum manifold.

In another embodiment of placing the liner into the mold, a robot hand apparatus applies a the liner into a mold with a static electricity generating apparatus for generating static electricity on a holding surface. For example, this static electricity generating apparatus may comprise a holding member attached to one side of a platelike base continuous with an arm of a robot and having a holding surface with substantially the same shape as that of the liner on the side opposite to the side where the liner is attached, tungsten wires stretched in grooves opened on the side of the holding surface in the holding member using securing members, high-voltage cables with static electricity shields that are connected to the tungsten wires and are led to a high-voltage power source, and a plurality of suction holes opened perpendicularly to the holding surface of the holding member and connected to a vacuum generating source. The electrostatic generating apparatus attracts the liner to a robot hand attracting surface by negative pressure, moves the robot hand in place in the mold, gives static electricity to the liner by the static electricity generating apparatus of the robot hand before and after the movement, and applies the liner into the mold.

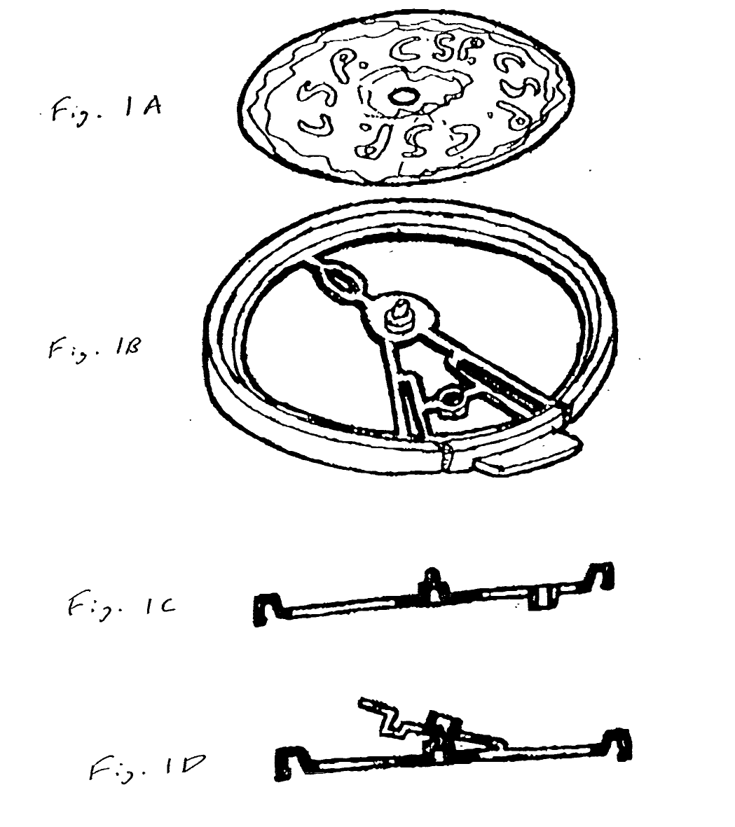

A further embodiment is shown in FIGS. 1A-D, 2A-C, 3 and 4. These figures illustrate a cover that can be secured to a cup. For example, the cover can be secured to a cup that holds a hot or cold liquid (e.g. coffee, tea, soda, other drinks and other types of food). The cover may serve to maintain the temperature of the liquid and/or to inhibit spillage of the liquid.

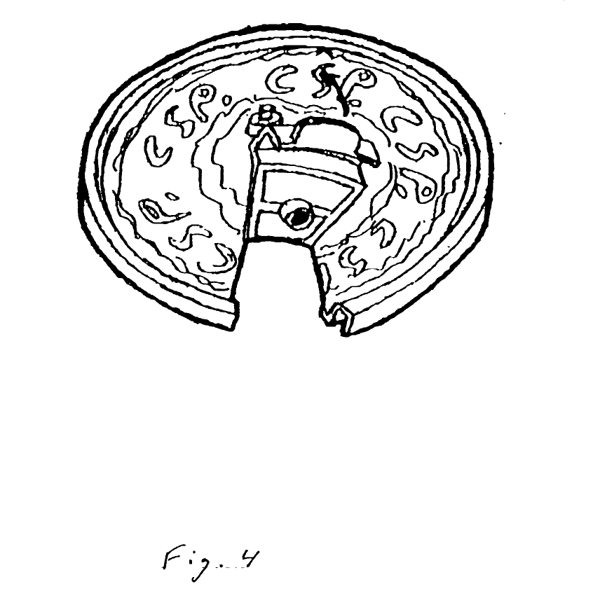

Specifically, FIGS. 1A through D illustrate one example of this embodiment, where FIG. 1A is a liner that is composed of a polymeric material (e.g. polypropylene). The liner can serve one or more functions as detailed above (e.g. a printed label on the outside, a barrier material). As shown in FIGS. 1A and 1B, the liner shown is FIG. 1A is pre-sized so that the liner can be properly fit into the frame shown in FIG. 1B. In one embodiment, the process is the in-mold liner process detailed above. For example, the liner is pre-printed (e.g. advertisement, directions for use, company name) and die-cut prior to insertion in the mold. Then, the liner is secured in the mold (e.g. by static electricity or other conventional methods) and the plastic (e.g. polypropylene) is injected into the mold to form the frame shown in FIG. 1B (i.e. the plastic frame is formed around the liner). At about the same time, the liner is secured to the frame by either the melting method or adhesive method discussed above. The result is a cover with the liner being an integral member of the frame. In a specific embodiment, as further shown in FIG. 1B, the frame can have one or more cross-members that go across the circular frame so as to give the liner structural support. Further, as shown in FIG. 1B, the frame can also have cross-members that are located from the circular frame in order to allow a part of the cover to be opened to allow access to the liquid contents. This access port is shown in FIG. 4 that shows the liner and frame structure with the access port opened. In addition, as further shown in FIG. 1B, in yet another embodiment, the frame can have a tab that extends out from the frame to assist in opening the access port. In another embodiment, the liner can have perforations that coincide with the frame members of the frame so as to allow ease in opening the access port.

FIG. 1C is a side views of one embodiment of the frame shown in FIG. 1B. FIG. 1D is a side view of the frame with the access port opened.

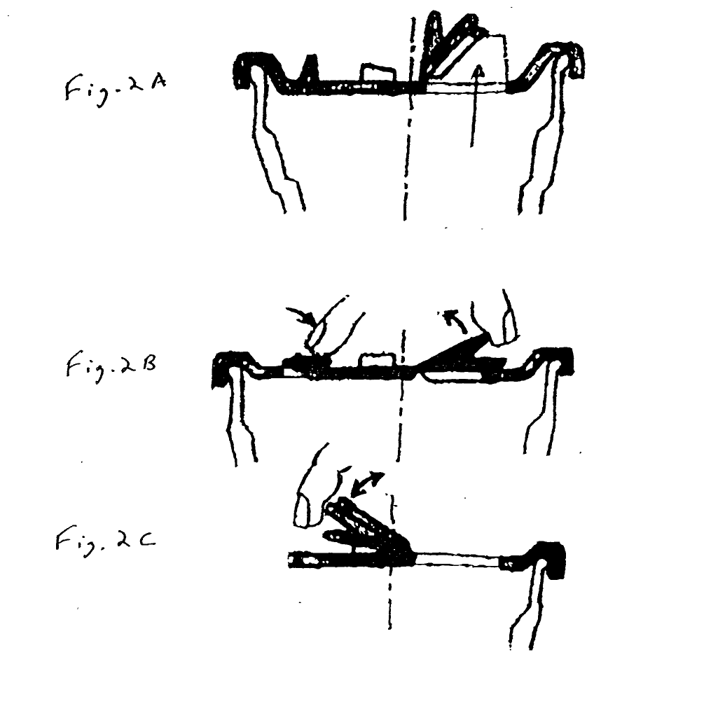

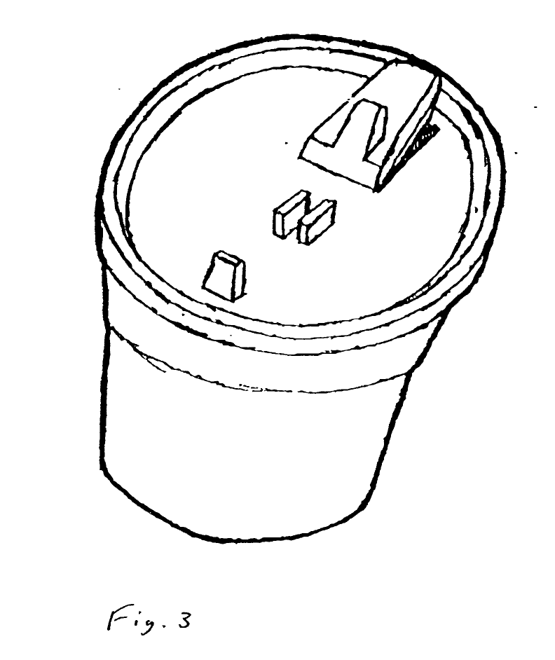

FIGS. 2A though 2C illustrate the operation of one embodiment with side views of the cover secured to a partial view of the cup. FIG. 2A shows the direction of the access port. FIG. 2B illustrates the opening of the access port on the right side with a finger. In another embodiment, the left side shows a vent open being opened by a finger. Further, FIG. 1B illustrates one embodiment of the vent hole with the top cross member having an oval hole. FIG. 2C then shows an embodiment where the access port is brought back to the point where it is secured to the opposite side of the liner. FIG. 3 illustrates an embodiment of the cover on the cup with the access port being partially opened and showing the securing member on the back-side of the access port and the top of the cover.

What is claimed is:

1. A container provided with a liner, wherein the container and liner are formed in a mold, the container comprised of a container body formed of a molded polymeric material, the container body defining a storage space in which an item can be stored, and wherein a molded liner is provided on at least a portion of a storage space side of the container body, wherein the liner is a composition comprising an absorption material.

2. The container of claim 1 wherein the absorption material is a desiccating compound.

3. The container of claim 1 wherein the desiccating compound is selected from the group consisting of hydrate-forming compounds, chemically reactive compounds, and compositions engaging in physical absorption.

4. The container of claim 1 wherein the absorption material is an anhydrous salt.

5. The container of claim 1 wherein the absorption material is selected from the group consisting of molecular sieves, silica gels, clays (e.g. montmorillimite clay), synthetic polymers, and starches.

6. The container of claim 1 wherein the absorption material is selected from the group consisting of metals and alloys including nickel, copper, aluminum, silicon, solder, silver, gold; metal-plated particulate including silver-plated copper, silver-placed nickel, silver-plated glass microspheres; inorganic materials including BaTiO₃, SrTiO₃, SiO₂, Al₂O₃, ZnO, TiO₂, MnO, CuO, Sb₂O₃, WC, fused silica, fumed silica, amorphous fused silica, sol-gel silica, sol-gel titanates, mixed titanates, ion exchange resins, lithium-containing ceramics, hollow glass microspheres; carbon-based materials including carbon, activated charcoal, carbon black, ketchem black, diamond powder; and elastomers including polybutadiene, polysiloxane, and materials including semi-metals, and ceramics.

7. The container of claim 1 wherein the absorption material is an absorber of CO₂.

8. The container of claim 7 wherein the absorption material is calcium oxide.

9. The container of claim 1 wherein the container body walls are formed of molded polymeric materials which provide a barrier to the passage of oxygen and wherein the liner composition is comprised of an oxygen absorbing material.

10. The container of claim 9 further comprised of an oxygen permeable skin layer positioned on the container storage space side of the container walls.

11. The container of claim 1 wherein the liner has a thickness from about 0.0001 inches to about 0.001 inches.

12. The container of claim 1 wherein the liner has a thickness from about 0.00025 inches to about 0.00075 inches.

13. The container of claim 1 wherein the liner is a foam.

14. A container provided with a liner, wherein the container and liner are formed in a mold, the container comprised of a container body formed of a molded polymeric material, the container body defining a storage space in which an item can be stored, wherein a liner is provided on at least a portion of a storage space side of the container body, wherein the liner is a composition comprising a releasing material.

15. The container of claim 14 wherein the releasing material releases a fragrance.

16. The container of claim 14 wherein the releasing material releases a flavor.

17. The container of claim 14 wherein the releasing material releases a compound selected from the group consisting of pesticides, pest repellents, antimicrobials, baits, aromatic therapeutic compositions, humidifying compositions, desiccating compositions; corrosion inhibitors; replenishers of gaseous compounds, and ripening agents.

18. The container of claim 14 wherein the releasing material is a biocide.

19. The container of claim 18 wherein the biocide biocides is selected from the group consisting of pesticides, herbicides, nematacides, fungicides, rodenticides and/or mixtures thereof.

20. The container of claim 14 wherein the releasing material is a fragrance selected from the group consisting of natural essential oils, synthetic perfumes, and mixtures thereof.

21. The container of claim 15 wherein the fragrance is selected from the group consisting of lemon oil, mandarin oil, clove leaf oil, petitgrain oil, cedar wood oil, patchouli oil, lavandin oil, neroli oil, ylang oil, rose absolute jasmin absolute; natural resins including labdanum resin or olibanum resin; alcohols including geraniol, nerol, citronellol, linalol, tetrahydrogeraniol, betaphenylethyl alcohol, methyl phenyl carbinol, dimethyl benzyl carbinol, menthol or cedrol; acetates and other esters derived form such alcohols-aldehydes such as citral, citronellal, hydroxycitronellal, lauric aldehyde, undecylenic aldehyde, cinnamaldehyde, amyl cinnamic aldehyde, vanillin or heliotropin; acetals derived from such aldehydes; ketones including methyl hexyl ketone, the ionones and methylionones; phenolic compounds including eugenol and isoeugenol; synthetic musks including musk xylene, musk ketone and ethylene brassylate.

22. The container of claim 14 wherein the liner has a thickness from about 0.0001 inches to about 0.001 inches.

23. The container of claim 14 wherein the liner has a thickness from about 0.00025 inches to about 0.00075 inches.

24. A container provided with a liner, wherein the container and liner are formed in a mold, the container comprised of a container body formed of a molded polymeric material, the container body defining a storage space in which an item can be stored, wherein a liner is provided on at least a portion of a storage space side of the container body, wherein the liner is a composition comprising an activation material.

25. The container of claim 24 wherein the activation material is activated by moisture.

26. The container of claim 24 wherein the activation material is activated by oxygen.

27. The container of claim 24 wherein the activation material is activated by an acid.

28. The container of claim 24 wherein the activation material is activated by a base.

29. The container of claim 24 wherein the activation material is activated by an enzyme system.

30. The container of claim 24 wherein the enzyme system is selected from the group consisting of glucose oxidase; a glucose/glucose oxidase combination; a glucose oxidase/sucrose combination; a starch/amylase/glucose oxidase combination; a cellulose/cellulase/glucose oxidase combination; a milk powder/lactase/glucose oxidase combination; a glucose oxidase/glucose isomerase/fructose combination; a glucose oxidase/lactase/whey solids/lactose combination; a glucose oxidase/lactase/lactose combination; a glucose oxidase/maltase/starch combination; a glucose oxidase/maltase/maltose combination; a mushroom tyrosinase/tyrosine combination; a glucose oxidase/sucrose/sucrase combination; an alcohol/alcohol oxidase; a lactate/lactate oxidase; an amino acid/amino acid oxidase; a golactose/golactose oxidase; a xanthine/xanthine oxidase; an amine/amine oxidase; an ascorbate/ascorbate oxidase; a chelione/chelione oxidase; and any combinations of these systems.

31. The container of claim 24 wherein the activation material generates hydrogen peroxide.

32. The container of claim 24 wherein the thickness of the liner is from about 0.0001 inches to about 0.001 inches.

33. The container of claim 24 wherein the thickness of the liner is from about 0.00025 inches to about 0.00075 inches.

34. A container provided with a liner, wherein the container and liner are formed in a mold, the container comprised of a container formed of a molded polymeric material, the container body defining a storage space in which an item can be stored, wherein a liner is provided on at least a portion of a storage space side of the container body, wherein the liner comprises a barrier material.

35. The container of claim wherein the liner exhibits oxygen barrier properties.

36. The container of claim wherein the liner is comprises ethylene vinyl alcohol.

37. A container provided with a liner, wherein the container and liner are formed in a mold, the container comprised of a container body formed of a molded polymeric material, the container body defining a storage space in which an item can be stored, wherein a liner is provided on at least a portion of a storage space side of the container body, wherein the liner comprises a permeability-enhancing material.

38. The container of claim 37 wherein the liner has a thickness from about 0.0001 inches to about 0.001 inches.

39. The container of claim 37 wherein the liner has a thickness from about 0.00025 inches to about 0.00075 inches.

40. A method of forming a container having a lining formed in the mold comprised of the steps of:
inserting a liner composition within a mold for forming a container, the liner composition comprising a material selected from the group consisting of an absorption material, a releasing material, a barrier material, and an activation material;
subsequently inserting a flowable plastic material into the mold at a position which locates the liner on an interior position of the container;
and closing the mold.

41. The method of claim 40 wherein the container is formed by extrusion.

42. The method of claim 40 wherein the container is formed by injection molding.

43. The method of claim 40 wherein the container is formed by blow molding.

44. The method of claim 40 wherein the liner is inserted in the mold by a pick and place mechanism.

45. The method of claim 40 wherein the liner is placed on the core prior to inserting the flowable polymeric material.

46. The method of claim 40 wherein the liner is retained on the core by applying a vacuum.

47. The method of claim 40 wherein the liner is retained on the core by applying an electrostatic charge to the core or label.

48. The method of claim 40 further comprised of the steps of first applying the liner to the core and then heating the liner with hot air to shrink the polymeric liner.

49. The method of claim 40 wherein the liner is tube-shaped insert that is inserted into the mold prior to inserting the flowable polymeric material.

50. A method of forming a container having a liner formed in the mold, comprising the steps of:
in a first position, placing a first liner composition on the core or a mold, the first liner composition comprising a material selected from the group consisting of an absorption material, a releasing material, a barrier material, and an activation material;
rotating the core to a second position;
closing the mold;
injecting a first plastic composition into the mold over the first liner;
opening the mold;
rotating the core to a third position;
placing a second liner over the core containing the injection molded plastic composition and the first liner, the second liner composition comprising a material selected from the group consisting of an absorption material, a releasing material, a barrier material, and an activation material;
rotating the core to a fourth position;
closing the mold;
injecting a second plastic composition into the mold; and
ejecting the container from the mold.

51. The container of claim 50 wherein the first liner composition is comprised of the same material as the second liner composition.

52. The container of claim 50 wherein the first liner composition is comprised of a different material than the second liner composition.

53. The container of claim 50 wherein first plastic composition is comprised of the same material as the second plastic composition.

54. The container of claim 50 wherein the first plastic composition is comprised of a different material than the second plastic composition.

55. A container provided with a liner, wherein the container and liner are formed in a mold, the container comprised of a container body formed of a molded polymeric material, the body defining a storage space in which an item can be stored, wherein a liner is provided on at least of a portion of an storage space side of the container walls, wherein the liner includes a label layer and a liner composition layer, the liner composition layer comprising a material selected from the group consisting of an absorption material, a releasing material, a barrier material, and an activation material.

56. The container of claim 55 wherein the label is provided with text or graphic information which faces an outer container wall.

57. The container of claim 55 wherein the label layer and the liner composition layer are co-laminated.

58. A container provided with a liner, wherein the container and liner are formed in a mold, the container comprised of a container body having walls formed of a molded polymeric materials, the walls defining a storage space in which an item can be stored, wherein a liner is provided on at least of a portion of a storage space side of the container walls, wherein the liner is comprised of a skin layer adjacent the storage space side of the container and a liner composition layer adjacent to the container walls comprised of a material selected from the group consisting of an absorption material, a releasing material, a barrier material, and an activation material.

59. The container of claim 58 wherein the skin layer is permeable with respect to a preselected component that is positioned in the liner composition layer or a preselected component positioned in the storage space side of the container.

60. A container provided with a liner, wherein the container and liner are formed in a mold, the container comprised of container body layers and liner layers, comprised of
a first molded inner liner layer, the first liner layer including a material selected from the group consisting of an absorption material, a releasing material,
a barrier material, and an activation material;
a first molded container body layer comprised of a first polymeric composition overlayed over the first liner layer;
a second molded intermediate liner layer, the second molded intermediate liner layer including a material selected from the group consisting of an absorption material, a releasing material, a barrier material, and an activation material;
the second molded intermediate liner overlayed over the first molded container body layer; and
a second molded container body layer comprised of a second polymeric composition overlayed over the second molded liner layer.

61. The container of claim 60 wherein the first molded inner liner layer is comprised of the same material as the second molded inner liner layer.

62. The container of claim 60 wherein the first molded inner liner layer is comprised of a different material than the second molded inner liner layer.

63. The container of claim 60 wherein first molded container body layer is comprised of the same material as the second molded container body layer.

64. The container of claim 60 wherein the first molded container body layer is comprised of a different material than the second molded container body layer.
